(19) United States
(12) Patent Application Publication
(10) Pub. No.: US 2007/0198195 A1
(43) Pub. Date: Aug. 23, 2007

(54) Determining Pharmacophore Features From Known Target Ligands

(76) Inventor: David E. Shaw, New York, NY (US)

Correspondence Address: FISH & RICHARDSON PC, P.O. BOX 1022, MINNEAPOLIS, MN, 55440-1022, US

(21) Appl. No.: 11/668,671

(22) Filed: Jan. 30, 2007

Related U.S. Application Data
(60) Provisional application No. 60/763,653, filed on Jan. 30, 2006.

(51) Int. Cl. G06F 19/00

(52) U.S. Cl. 702/19; 702/22

(57) ABSTRACT

A computational method of determining a set of proposed pharmacophore features describing interactions between a known biological target and known training ligands that show activity towards the biological target.

### CLAIM OF PRIORITY

This application claims priority under 35 U.S.C. §119 to U.S. provisional application Ser. No. 60/763,653, filed Jan. 30, 2006, the entirety of which is incorporated by reference herein.

### TECHNICAL FIELD

This invention relates to identifying common pharmacophore models for ligand/biological target interaction, through analysis of a set of ligands known to have activity against a specified biological target.

### BACKGROUND AND SUMMARY OF THE INVENTION

Certain large, naturally-occurring organic molecules (typically proteins, glycoproteins or lipoproteins) can mediate one or more biochemical processes in a living organism, and their function can be modulated by interaction with other molecules, either naturally occurring or man made. Often, the large organic molecule is a receptor or an enzyme. We generally use the term “biological target” or simply “target” to refer to such large organic molecules, and we use the term “ligand” to refer to molecules that interact with the biological target to modulate its function.

Various techniques are used to identify the spatial arrangements of chemical features that are responsible for binding between a biological target and its ligand. These spatial arrangements are commonly referred to as “pharmacophore models” or “pharmacophore hypotheses,” and the chemical features are frequently categorized as: a) hydrogen bond acceptor (“A”); b) hydrogen bond donor (“D”); c) hydrophobe (“H”); d) negative ionizable (“N”); e) positive ionizable (“P”); and f) aromatic rings (“R”). Certain techniques are known to identify pharmacophore models that are consistent with the known behavior of ligands, with and without the use of information from the associated biological target (see, e.g., (a) Pharmacophore Perception, Development, and Use in Drug Design; Güiner, Osman, Ed.; International University Line: LaJolla, Calif., 1999; (b) Patel, Y.; Gillet, V. J.; Bravi, G; Leach, A. R. A Comparison of the Pharmacophore Identification Programs: Catalyst, DISCO and GASP. J Comput.-Aided Mol Design. 2002, 16, 653-681; Greene, J.; Kahn, S.; Savoj, H.; Sprague, P.; Teig, S.; Chemical Function Queries for 3D Database Search. J. Chem. Inf. Comput. Sci. 1994, 34, 1297-1308; Barnum, D.; Greene, J.; Smellie, A.; Sprague, P. Identification of Common Functional Configurations Among Molecules. J. Chem. Inf Comput. Sci. 1996, 36, 563-571; Van Drie, J. Strategies for the Determination of Pharmacophoric 3D Database Queries. J. Comput.-Aided Mol. Design 1997, 11, 39-52.). In cases where co-crystallized ligand/target complexes have been determined, it generally is possible to align target backbone atoms thereby obtaining a superposition of the ligands with key features overlapping in a common frame of reference. FIG. 1 displays three examples of ligand superpositions obtained from three sets of co-crystallized complexes in the Protein Data Bank (PDB).

Many proteins or complexes are extremely difficult to crystallize (e.g. G-protein coupled receptors, or GPCRs). For this or other reasons, co-crystallized complexes may not be available, and it is desirable to deduce ligand superpositions even without the availability of co-crystallized experimental data or, in many cases, without any target structure at all. In these situations, pharmacophore perception (generation of pharmacophore models or hypotheses using structural data from known active ligands) is one of the few computational approaches capable of predicting how ligands bind in these systems. Even though they may generally lack the accuracy of the experimental structure determination (e.g. through x-ray crystallography), pharmacophore models are extremely valuable for lead discovery and lead optimization, as discussed further below.

In the absence of crystallographic data, pharmacophore models may be developed through analysis of pharmacophore feature data within a conformational database (a set of plausible 3D chemical structures) of known active ligands (“actives”). The critical aspect of this process is identifying subsets of pharmacophore sites (typically between 3 and 7) that are spatially arranged in a very similar manner across all actives, or some minimum required number of actives. Thus, for a given spatial arrangement of a given number (“k”) of pharmacophore features within some conformation of a single active, at least one conformation from each of the other actives is sought that contains the same features positioned in the same manner (within a predefined tolerance). When such an arrangement is found, a superposition of all actives is provided and a proposed pharmacophore hypothesis having k points emerges. Additional computational techniques may then be applied to assign a score to each hypothesis based on the quality of the superposition, and, optionally, based on a combination of heuristic measures.

Once a pharmacophore model is developed, it can be used to locate new active compounds within a 3D database, i.e., a conformational database augmented with pharmacophore site data. Hits are conformations within such a 3D database that are found to contain an arrangement of pharmacophore site points that can be mapped to a pharmacophore hypothesis. A hit is not necessarily active, but it is presumed to have a greater than average probability of being active if it was retrieved using a valid hypothesis. Each hit returned from a database search satisfies the pharmacophore model to within a preset tolerance, and if the model is sufficiently accurate, the hits should be enriched with active compounds (compared to the original database). The process is very rapid, and databases containing more than 10⁶ compounds can be searched routinely.

The pharmacophore model may also be used in the context of lead optimization. Molecules that match a hypothesis on three or more sites can be aligned unambiguously, which allows a series of molecules of varying activity to be superposed in a chemically meaningful way. This superposition can be used to develop a 3D Quantitative Structure-Activity Relationship (QSAR), which may in turn be applied to identify new compounds with high potency and superior pharmacokinetic profiles.

The present invention particularly emphasizes the mechanics of identifying a common pharmacophore model, one that is based on the premise that ligand-target binding involves a specific set of interactions in which all actives engage. This task is the most technically demanding aspect of the overall process because each active may be represented by thousands of conformations, each conformation may contain hundreds or thousands of k-point pharmacophores, and each k-point pharmacophore must be confirmed or rejected as being common among the actives.

A set of pharmacophore features with no implied 3D structure may be represented by a “variant,” which is a concatenation of one-letter pharmacophore feature designations. For example, the variant “AHH” refers to the family of three-point pharmacophores containing one hydrogen bond acceptor and two hydrophobes. In principle, all pharmacophores of a given variant must be compared between all pairs of actives in a training set (a collection of active molecules from which a model is developed) to determine which pharmacophores from that variant are common to all actives. Thus if there are 10 active compounds, 1000 conformations per compound, and 100 k-point pharmacophores for a particular variant in each conformation, the number of comparisons required is at least (1000·100)²·(10·9)/2=4.5×10¹¹. This estimation does not include all the different mappings that arise for a variant containing more than one occurrence of a given feature type. For example, there are 12 unique ways to map, and therefore align, any two pharmacophores of the variant AAHHH (see below for further explanation). This process has to be carried out for each possible variant, of which there may be dozens. A brute force approach would imply that each of these possibilities must be examined, requiring the execution of an enormous number of instructions and floating point operations. It is clear that algorithms which reduce the computational complexity of the problem are required if a solution is to be made practical.

A number of algorithms have been described in the literature to address the problem of common pharmacophore perception ((a) Van Drie, J. H.; Weininger, D.; Martin, Y. C. ALADDIN: An Integrated Tool for Computer-Assisted Molecular Design and Pharmacophore Recognition from Geometric, Steric, and Substructure Searching of Three-Dimensional Molecular Structures. J. Comput.-Aided Mol. Design 1989, 3, 225-251; (b) Martin, Y.; Bures, M.; Danaher, E.; DeLazzer, J.; Lico, I.; Pavlik, P. A. A Fast New Approach to Pharmacophore Mapping and its Application to Dopaminergic and Benzodiazepine Agonists. J. Comput. Aided Mol. Design. 1993, 7, 83-102; (c) Jones, G.; Willett, P.; Glen, R. C.; A Genetic Algorithm for Flexible Molecular Overlay and Pharmacophore Elucidation. Journal of Comput.-Aided Mol. Design 1995, 9, 532-549; (d) Barnum, D.; Greene, J.; Smellie, A.; Sprague, P. Identification of Common Functional Configurations Among Molecules. J. Chem. Inf. Comput. Sci. 1996, 36, 563-571; (e) Holliday, J. D.; Willett, P. Using a Genetic Algorithm to Identify Common Structural Features in Sets of Ligands. J. Mol. Graph. Model. 1997, 15, 221-232; (f) Gardiner, E. J.; Artymiuk, P. J.; Willett, P. Clique-Detection Algorithms for Matching Three-Dimensional Molecular Structures. J. Mol. Graph. Model. 1997, 15, 245-253.). Typically these techniques require the use of uncontrolled approximations, in which large populations of models are summarily eliminated from consideration based on heuristic criteria. A serious drawback of such an approach is that the common pharmacophore space explored typically is incomplete, which reduces the possibility of identifying a model that adequately describes the mode in which ligands bind to the target.

The invention features computerized partitioning that enables a direct, exhaustive search of the space of common k-point pharmacophores, while possessing acceptable computational requirements for many, if not most, pharmacophore generation problems of practical interest. We use the phrase “hierarchical partitioning” to refer to generating progressively smaller spaces from an initial top-level (k·(k−1))/2-dimensional space defining permitted distance ranges for each dimension of intersite distance (ISD) vectors that represent k-dimensional pharmacophores. This contrasts with methods relying primarily on a buildup procedure, wherein common 3-point pharmacophores are first identified and scored (with elimination of low-scoring 3-point pharmacophores), then augmented with an additional point to generate common 4-point pharmacophores, and so on (Barnum, D.; et al. J. Chem. Inf. Comput. Sci. 1996, 36, 563-571).

More specifically, in one aspect, the invention may be generally stated as a computational method of determining a set of proposed pharmacophore features describing interactions between a known biological target and a set of training ligands that show activity towards the biological target. The method includes: a) obtaining a set of ISD vectors, the set comprising ISD vectors for each of two or more training ligands, each of the ISD vectors being associated with a specific set of pharmacophore sites within a single conformation of one of the training ligands, each of the ISD vectors having the same number and types of pharmacophore sites as other ISD vectors in the set; b) determining a top-level multi-dimensional space for the set of ISD vectors, and c) using a computerized process of hierarchical partitioning to calculate from the top-level multi-dimensional space a refined multi-dimensional space defining the permitted distance ranges for each dimension of the ISD vectors in each of at least three dimensions. Preferably, the hierarchical partitioning step includes generating a tree of ISD vectors that correspond to progressively smaller regions of permitted space, by dividing each multi-dimensional space into a first generation of subspaces, and evaluating the first generation of subspaces by determining whether each first generation subspace and/or its neighbor region includes an ISD vector from each training ligand. If the required ISD vectors are not found in a first generation subspace or its neighboring region, that first generation subspace is omitted from further steps. Those subspaces which are not omitted are further subdivided to create a second generation of subspaces, which is evaluated as with the first generation to omit subspaces where an ISD vector from each training is not found in the subspace or its neighboring region. The remaining second generation substances are optionally further subdivided to generate refined pharmacophore-containing multi-dimensional spaces. A set of pharmacophore features may then be produced, based on the refined pharmacophore-containing multi-dimensional spaces. The user may define a terminal generation by specifying a minimum permitted distance range applicable to all dimensions of each ISD vector subspace.

To enhance the ability to treat exceptionally demanding datasets, computer-readable data representative of the top-level multi-dimensional space optionally may be stored in partitioned storage, and portions of the data are processed in RAM of a computer.

In general, in one aspect, a computational method of determining a set of proposed pharmacophore features describing interactions between a known biological target and a set of ligands that show activity towards the biological target includes: identifying a set of n-dimensional inter-site distance (ISD) vectors, the set including at least one ISD vector from each of two or more ligands. Each of the ISD vectors is associated with a specific set of pharmacophore sites within a single conformation of one of the ligands. The sites are identical in number and type to the pharmacophore features from which the set of ISD vectors is defined. Determining the set of proposed pharmacophore features also includes using a computerized process of hierarchical partitioning to determine, from a top-level multi-dimensional space, a refined, smaller multi-dimensional space defining the distance ranges for each dimension of the ISD vectors. The distance ranges are used to propose spatial relationships among the set of pharmacophore features.

Implementations may have one or more of the following features. The process of hierarchical partitioning includes: identifying a minimum distance range ε; identifying a dimension i of the ISD vectors; identifying a range of values of the ith dimension of the ISD vectors; partitioning the range of values into intervals; identifying each interval that includes the values of the ith coordinate of ISD vectors from at least a predetermined number of ligands; and iteratively partitioning only the intervals that include ith coordinates of the predetermined number of ISD vectors, until a stopping condition is met. The computational method also includes identifying a minimum distance ε, in which an overlap of any two intervals is at most ε, and in which the stopping condition includes that a size of each interval does not exceed ε. The hierarchical partitioning step includes generating a tree of ISD vector sets covering progressively smaller regions of multi-dimensional space, by dividing each multi-dimensional space into a first generation of subspaces, and evaluating the first generation of subspaces by determining whether each first generation subspace and/or its neighbor region includes an ISD vector from each of a predetermined number of ligands; if the required ISD vectors do not occur in a first generation subspace or its neighboring region, omitting that first generation subspace from further steps, those subspaces which are not omitted being the remaining first generation subspaces; and further subdividing the remaining first generation subspaces to create a second generation of subspaces, and evaluating the second generation of subspaces to produce remaining second generation subspaces, and optionally further subdividing the remaining second generation subspaces to generate refined pharmacophore-containing multi-dimensional spaces and proposing a set of pharmacophore features based on the refined pharmacophore-containing multi-dimensional spaces. Computer-readable data representative of at least the top-level multi-dimensional space is stored in partitioned storage, and portions of the data are processed in RAM of a computer. A user may define a terminal generation by specifying a minimum distance range applicable to all dimensions of each ISD vector subspace. Each of the pharmacophore sites is characterized by one or more of the following chemical features: a) hydrogen bond acceptor; b) hydrogen bond donor; c) hydrophobe; d) negative ionizable; e) positive ionizable; and f) aromatic ring. The number of dimensions n is between 7 and 21. The proposed set of pharmacophore features is used to select candidate drugs from a library of potential drugs. One or more candidate drugs is subjected to an experimental evaluation. Data from said experimental evaluation is used to add at least one of the candidate drugs to the set of ligands to produce a revised set of ligands and the steps of claim are repeated using the revised set of ligands. The set of ISD vectors is initially stored on a disk on a computer, and the method also includes: identifying a memory threshold LD; storing results of the iterative partitioning on the disk when the results exceed the memory threshold; and storing the results of the iterative partitioning in a memory of the computer when the results meet the memory threshold LD.

Other aspects include other combinations of the features recited above and other features, expressed as methods, apparatus, systems, program products, computer-readable media, and in other ways.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 depicts superpositions obtained from crystallographic complexes in the Protein Data Bank: (a) thrombin inhibitors; (b) dihydrofolate reductase inhibitors; and (c) influenza neuraminidase inhibitors.

FIG. 2 depicts construction of a hypothetical six-dimensional ISD vector from a four-point pharmacophore within an endothelin ligand.

FIG. 3 depicts comparison of ligand superpositions obtained from crystallographic data and from the pharmacophore method described in this invention using: (a) thrombin inhibitors; (b) dihydrofolate reductase inhibitors; and (c) influenza neuraminidase.

FIG. 4 depicts accessible conformations for a molecule with a single rotatable bond.

FIG. 5 enumerates five-point pharmacophores for the variant AADHH.

FIG. 6 is a diagram of leaf-level boxes for a hypothetical two-dimensional case involving two ligands.

FIG. 7 illustrates the first four levels of a sample search tree for the case of two ligands (again, reduced to two dimensions in the interest of clarity).

### DETAILED DESCRIPTION

The present invention provides methods and apparatus, including a computer program, for perception or generation of common pharmacophore models given a set of input molecules. Candidate pharmacophore hypotheses are generated by the algorithm, and then ranked by a scoring function.

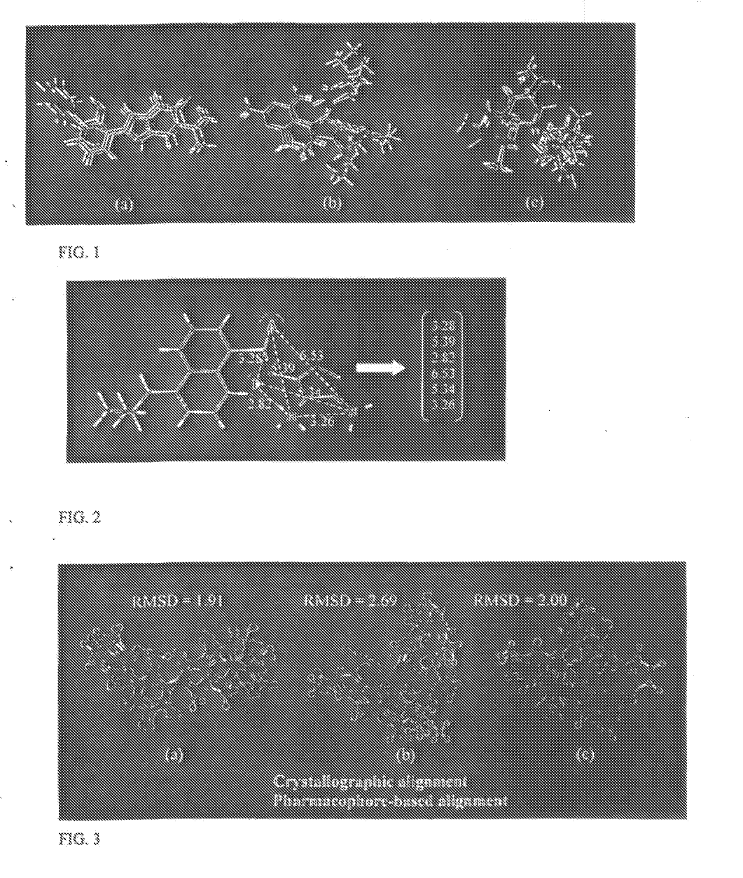

The invention operates on vectors defining the distance between a pair of site points in a pharmacophore from two or more compounds that show activity toward a particular biological target. An ISD vector expresses as a vector the set of (k·(k−1))/2 non-redundant intersite distances in a k-point pharmacophore. Each ISD vector is associated with a specific set of pharmacophore sites within a single conformation of a particular compound. FIG. 2 illustrates how a six-dimensional ISD vector is defined from a four-point pharmacophore embedded within a ligand of the endothelin receptor.

One embodiment of the invention is a computer implemented method for performing hierarchical “partitioning” of a set of ISD vectors from the various members of the training set into multidimensional “boxes” that reside in intersite distance space. A box defines the permitted range of distances for each dimension of the ISD vector. The difference between the largest and smallest distance values corresponds to the length of the box in a particular dimension. When ISD vectors from each of the training set molecules occupy the same final (small) box in ISD space, the pharmacophores from all of such molecules are sufficiently similar to permit superposition of corresponding pharmacophore features in 3D space, excluding mirror image effects.¹ The partitioning algorithm thus provides a prescription for constructing 3D superpositions of the active compounds, which can then be quantitatively ranked using a scoring function, and returned to the user.
¹The ISD vector for a given set of points is identical to the ISD vector obtained from the mirror image arrangement of those points; however, the two sets of points may not be superimposable in 3D space. The partitioning algorithm cannot detect this effect, but the subsequent step of scoring hypotheses includes provisions for identifying and eliminating pharmacophores that fail to superpose in 3D space.

Partitioning is carried out on sets of ISD vectors, which are identical with regard to the number of pharmacophore sites (typically between 3 and 7) and variant. Each variant can be analyzed separately because pharmacophores cannot be superposed if they do not contain exactly the same number and types of pharmacophore features.

The basic problem addressed by the partitioning algorithm is to sort the relevant set of distance geometry vectors into boxes. This is a classic multidimensional sorting problem in computer science. A further characteristic of the present problem is that a “fuzzy” sort is required, as opposed to a precise sort. That is, if the distance values in a given dimension of two vectors differ by less than the specified tolerance (typically on the order of 2 Angstroms), the relative ordering of the two values in that dimension is not important. The version of the partitioning algorithm that we employ is specifically designed to optimize efficiency for fuzzy sorting of this type.

The invention has one or more of the following advantages.

1. Computational effort for the fuzzy sorting process using the partitioning algorithm scales as N·logN, where N is the total number of ISD vectors associated with the variant being processed, is reduced. This is a dramatic improvement over the order N² scaling of a brute force algorithm in which all pharmacophores between each pair of molecules are compared.

2. The algorithm is effectively exhaustive; it considers all possible pharmacophores present in a training set of molecules and partitions them into boxes that satisfy the user specified tolerances for pharmacophore matching. This can be contrasted with other algorithms in the literature, which achieve computational tractability by making heuristic approximations that reduce the pharmacophore space actually analyzed.

3. The code implementing the partitioning algorithm is relatively compact and systematic. This facilitates maintenance and improvement of the code in the future.

4. The invention permits use of partitioned storage, thereby increasing the capacity of information that can be stored and analyzed.

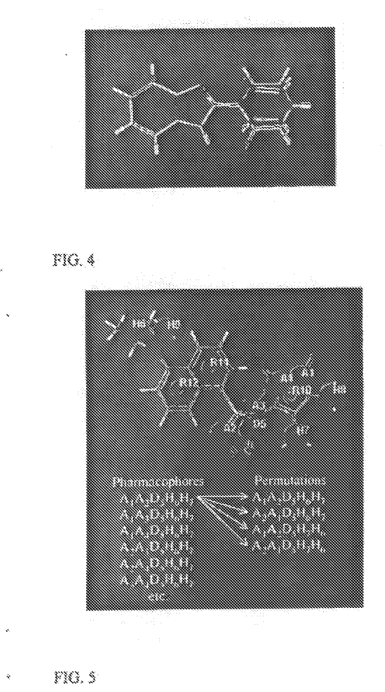

FIG. 3 displays ligand superpositions obtained from experimental data, and from using the 3D pharmacophore method described herein, for the biological targets thrombin, dihydrofolate reductase, and influenza neuramidinase. The root-mean-squared atomic deviations indicate that there is good agreement between the predicted and experimental superpositions. These results illustrate the power of a 3D pharmacophore method to predict bioactive conformations and relative orientations of ligands without the aid of crystallographic data.

The first step is to generate energetically accessible conformations of each molecule in the training set. FIG. 4 displays energetically accessible conformations for a molecule with only one rotatable bond. Other molecules, which possess more rotatable bonds, have much larger numbers of accessible conformations. The current implementation of the invention is packaged with a program that generates conformations and can eliminate those whose energy is judged to be too high.

The next step is to specify the number of sites k and the variant v of the pharmacophores to be investigated. The partitioning algorithm has the objective of finding all common k-point pharmacophores for that variant. Accordingly, ISD vectors are constructed from all k-point pharmacophores of variant v among all conformations of the training set molecules.

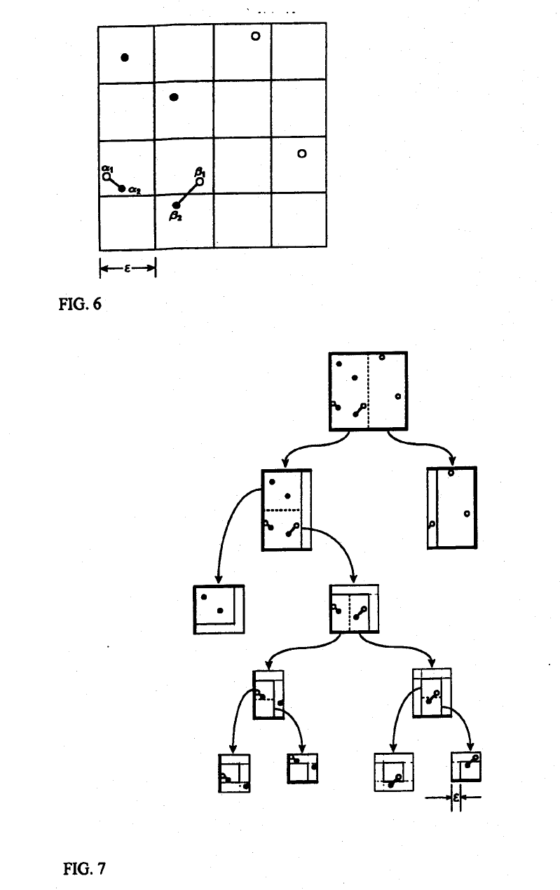

FIG. 5 illustrates this process for a single conformation of an endothelin ligand, with k=5 and v=AADHH. This ligand contains 12 pharmacophore sites, which give rise to 36 5-point pharmacophores of the type AADHH. Further, because there are two acceptors (A) and two hydrophobes (H), the sites in these 36 pharmacophores can be permuted four unique ways to yield four ISD vectors. Table 1 shows six of the 144 ISD vectors arising from this single conformation.

TABLE 1
Example ISD vectors for AADHH pharmacophores
from the ligand in FIG. 5.

| Pharmacophore | d_{AA′} | d_{AD} | d_{A′D} | d_{AH} | d_{A′H} | d_{DH} | d_{AH′} | d_{A′H′} | d_{DH′} | d_{HH′} |
|---|---|---|---|---|---|---|---|---|---|---|
| A₁A₂D₅H₆H₇ | 5.90 | 4.20 | 2.59 | 10.47 | 8.29 | 9.30 | 3.68 | 5.28 | 2.87 | 11.77 |
| A₁A₃D₅H₆H₇ | 4.52 | 4.20 | 3.34 | 10.47 | 8.89 | 9.30 | 3.68 | 5.21 | 2.87 | 11.77 |
| A₁A₄D₅H₆H₇ | 1.42 | 4.20 | 3.20 | 10.47 | 9.32 | 9.30 | 3.68 | 3.71 | 2.87 | 11.77 |
| A₂A₃D₅H₆H₇ | 2.50 | 2.59 | 3.34 | 8.29 | 8.89 | 9.30 | 5.28 | 5.21 | 2.87 | 11.77 |
| A₂A₄D₅H₆H₇ | 4.59 | 2.59 | 3.20 | 8.29 | 9.32 | 9.29 | 5.28 | 3.71 | 2.87 | 11.77 |
| A₃A₄D₅H₆H₇ | 3.30 | 3.34 | 3.20 | 8.89 | 9.32 | 9.30 | 5.21 | 3.71 | 2.87 | 11.77 |

As ISD vectors are culled from all conformations of the training set molecules, they are written to a single file, after which the partitioning algorithm is initiated.

The partitioning algorithm begins by placing the ISD vectors in an n-dimensional box (where n is the number of dimensions in the ISD vector) referred to as the top-level box. The minimum and maximum values of each dimension in the top-level box can be determined from the corresponding limits over all ISD vectors. The set of ISD vectors associated with the top-level box is referred to as the top-level ISD list. At the beginning of the partitioning process, the top-level box is bisected along the first dimension, and each of the two resulting sub-boxes is assigned an ISD list containing all ISD vectors from the top-level list whose first distance falls within the limits of that sub-box (along with certain additional ISD vectors, as discussed in the following subsection). Next, each of these two sub-boxes is similarly bisected along the second dimension, after which the four resulting sub-boxes are bisected along the third dimension, and so forth. After bisection along the nth dimension, the process “wraps around” again to the first dimension and continues. The dimension along which boxes are bisected at any given stage of the partitioning process is referred to as the split dimension.

This process of hierarchical partitioning may be thought of as generating a search tree of progressively smaller boxes, associated with progressively shorter ISD lists. Each successive bisection corresponds to a new level within the tree. At each level, the two sub-boxes produced when a given parent box is bisected are referred to as the children of that box. Under certain circumstances (discussed below), however, one or both children will be eliminated from the search tree, in which case they will not produce any descendants of their own. Once the process of successive bisection reduces the boxes to some user-specified minimal size, the partitioning algorithm terminates. The level at which the partitioning process terminates is referred to as the leaf level of the search tree. Each surviving n dimensional box at the leaf level is referred to as a solution box. At the end of the partitioning process, the set of all surviving solution boxes will together contain all common pharmacophores for the given set of ligands.

Each time a parent box is bisected to create two child boxes, the ISD list of the parent must be examined to decide which of its ISD vectors should be included in the ISD list of its children. For reasons that will become clear in the following subsection, the partitioning algorithm always makes this decision in such a way as to ensure that each child's ISD list contains all information that will ultimately be required to determine which of its ISD vectors represent solution pharmacophores. If the ISD list were to contain only those ISD vectors that fall within the physical boundaries of the child box, however, we could not in general guarantee that this condition is satisfied.

To see why this is the case, consider FIG. 6. This example, which has been limited to two dimensions for expository purposes, shows a set of 16 leaf-level boxes, each with side length ε, under the simplifying assumption that no boxes have been eliminated in the course of partitioning. ISD vectors α₁ and α₂, arising from ligands 1 and 2, respectively, reside within the same leaf-level box, and are thus guaranteed to be separated by no more than ε in either dimension. ISD vectors β₁ and β₂ are also separated by less than ε in each dimension, but do not reside within the same box. Thus, if the ISD list of each box contained only the ISD vectors of pharmacophores that fall within the physical limits of that box, no single leaf-level box would contain the information required to identify these two candidates as solution pharmacophores.

To avoid this problem, each child also receives a copy of certain ISD vectors held by its parent that fall outside the limits of the child box. Suppose, for example, that a given box at a particular level within the search tree extends from a to c along the split dimension. This box will be split at the midpoint b=(a+c)/2 into two child boxes: box B_{L}, extending from a to b, and box B_{U}, extending from b to c. The ISD list associated with box B_{L} will consist of a home sublist containing all ISD vectors whose split dimension distance lies on the interval [a, b] (the home region), together with a neighbor sublist containing all ISD vectors whose split dimension distance lies on the interval [b, b+ε] (the neighbor region).² Similarly, the ISD list associated with box B_{U} will include not only a home sublist containing all ISD vectors associated with the interval [b, c], but also a neighbor sublist containing ISD vectors associated with the interval [b−ε, b].
² If there are only two ligands, it is actually possible to restrict the neighbor region to extend only a distance of ε/2, rather than ε, into the other child box, but this does not generalize to the case of three or more ligands.

To verify the adequacy of this approach, consider two ISD vectors p₁ and p₂ from ligands 1 and 2, respectively, that are separated by no more than a distance ε in any dimension. If p₁ appears in the home sublist of some leaf-level box B, it is easily shown that p₂ will appear in either the home or neighbor sublist of B. The same statement can of course be made with the two ISD vectors and the two boxes interchanged. This result has two implications. First, all pharmacophores that qualify as solution pharmacophores will be identified as such by the partitioning algorithm, since for all pairs of nearby pharmacophore candidates, there will always be at least one leaf-level box whose ISD list includes both such candidates. Second, this result allows us to safely eliminate from consideration any box B that fails to satisfy either of the following survival criteria:

(1) At least one ISD vector (from any ligand) appears in the home sublist of

(2) At least one ISD vector from each of the other ligands³ appears in either the home or neighbor sublist of box B.
³ Tis condition can be relaxed to require only some minimum number of ligands to be represented in the sublists. When the ligands being analyzed bind in two or more distinct modes, this sort of approach may be necessary in order to identify pharmacophores that are common to the ligands of each binding mode.

At each level within the search tree, any box B that fails to satisfy both of the above survival criteria cannot possibly contain a solution pharmacophore, and thus need not be considered further. By eliminating such boxes, the partitioning algorithm effectively “prunes” the search tree, thus saving the time and storage that would otherwise be required to partition not only B, but also the entire subtree rooted by B. In the absence of such pruning, the number of neighbor ISD vectors would, in general, become prohibitively large for most realistic problems.

This phenomenon represents a particular manifestation of what is often referred to as the curse of dimensionality. (Bellman, R. Adaptive Control Processes: A Guided Tour; Princeton University Press: Princeton, N.J., 1961). Without some problem-specific mechanism for limiting the size of the effective search space, the task of identifying all nearby points in a multidimensional space containing many such points is in general prohibitively costly unless the number of dimensions is quite small. By ensuring that each leaf-level box has a record of all nearby ISD vectors, the hierarchical partitioning approach avoids the need for such a multidimensional search. In the absence of special measures, this would come at the cost of an equally problematic proliferation of ISD vectors. For this reason, the pruning of larger boxes that can be shown to contain no solution pharmacophores is essential to the practicality of the partitioning algorithm.

FIG. 7 illustrates the first four levels of a sample search tree for the case of two ligands (again, reduced to two dimensions in the interest of clarity). In this example, the algorithm begins by bisecting the top-level box along a vertical axis into two child boxes. The home sublist of the left child (corresponding to the blue region) contains ISD vectors from both ligands, and thus satisfies the survival criteria. The right child, however, does not satisfy those criteria, since all ISD vectors in both its home sublist (blue region) and neighbor sublist (green region) arise from a single ligand. The left child is thus further subdivided, while the right child is eliminated, and generates no offspring. At the next level in the tree, the surviving child is split along a horizontal axis, once again generating two children, only one of which survives. Wrapping around the list of dimensions, the surviving child is then bisected again along a vertical axis, in this case generating two surviving children. Each of these is split along a horizontal axis, generating a total of four children, all of which survive except the box second from the left. The rightmost of these four provides an example of a box whose survival is dependent on the combined home and neighbor sublists, because the home sublist contains an ISD vector from only one ligand. After the partitioning process has been completed, any surviving boxes would be passed along to the post-partitioning routine, the output of which would be a (possibly empty) set of plausible pharmacophore hypotheses.

Disk-Based Partitioning

The preceding description of the partitioning algorithm applies when all ISD vectors of a given variant fit into main memory. Because large ligands can produce millions of ISD vectors, the proliferation of neighbor lists may increase memory requirements beyond the installed system RAM of the computer system. In these cases, the top-level box is partitioned on disk to a disk based depth LD that depends on n, the number of dimensions in the ISD vectors. By default, LD=n, such that each dimension in the top-level box is split only once. As the ISD vectors are created in the top-level box, they are stored to disk. The root box file is divided into manageable chunks of ISD vectors that can be partitioned in main memory. Each successive chunk is read from disk, then partitioned LD levels in the manner described previously with the following two exceptions: (1) no boxes are eliminated during the disk-based partitioning, and (2) the boxes at level LD are stored to disk. If a box at level LD already exists on disk and has ISD vectors stored from a previously processed root box chunk, additional ISD vectors can be added to the LD level disk-based box file as successive root box chunks are processed.

After all the chunks of the root box have been partitioned to level LD, the boxes at this level of the binary tree that were stored to disk are examined. As described in the general partitioning algorithm, boxes that do not have ISD vectors from all ligands (or some minimum required number of ligands) are erased from disk. If a box is still too large for main memory, it is partitioned on disk again in the same manner as the disk based partitioning of the root. Once the box size has been reduced to fit into main memory, the box is partitioned in main memory to the termination level LT as described in the general partitioning scheme.

A number of embodiments of the invention have been described. Nevertheless, it will be understood that various modifications may be made without departing from the spirit and scope of the invention.

What is claimed is:

1. A computational method of determining a set of proposed pharmacophore features describing interactions between a known biological target and a set of ligands that show activity towards the biological target, the method comprising:
identifying a set of n-dimensional inter-site distance (ISD) vectors, the set comprising at least one ISD vector from each of two or more ligands, each of the ISD vectors being associated with a specific set of pharmacophore sites within a single conformation of one of the ligands, the sites being identical in number and type to the pharmacophore features from which the set of ISD vectors is defined; and
using a computerized process of hierarchical partitioning to determine, from a top-level multi-dimensional space, a refined, smaller multi-dimensional space defining the distance ranges for each dimension of the ISD vectors, said distance ranges being used to propose spatial relationships among said set of pharmacophore features.

2. The method of claim 1, in which the process of hierarchical partitioning includes:
identifying a minimum distance range ε;
identifying a dimension i of the ISD vectors;
identifying a range of values of the ith dimension of the ISD vectors;
partitioning the range of values into intervals;
identifying each interval that includes the values of the ith coordinate of ISD vectors from at least a predetermined number of ligands; and
iteratively partitioning only the intervals that include ith coordinates of the predetermined number of ISD vectors, until a stopping condition is met.

3. The method of claim 2, further comprising identifying a minimum distance ε, in which an overlap of any two intervals is at most ε, and in which the stopping condition includes that a size of each interval does not exceed ε.

4. The method of claim 1 in which the hierarchical partitioning step comprises generating a tree of ISD vector sets covering progressively smaller regions of multi-dimensional space, by dividing each multi-dimensional space into a first generation of subspaces, and evaluating the first generation of subspaces by
determining whether each first generation subspace and/or its neighbor region includes an ISD vector from each of a predetermined number of ligands;
if the required ISD vectors do not occur in a first generation subspace or its neighboring region, omitting that first generation subspace from further steps, those subspaces which are not omitted being the remaining first generation subspaces;
further subdividing the remaining first generation subspaces to create a second generation of subspaces, and evaluating the second generation of subspaces to produce remaining second generation subspaces;
optionally further subdividing the remaining second generation subspaces to generate refined pharmacophore-containing multi-dimensional spaces; and
proposing a set of pharmacophore features based on the refined pharmacophore-containing multi-dimensional spaces.

5. The method of claim 1 or claim 4 in which computer-readable data representative of at least the top-level multi-dimensional space is stored in partitioned storage, and portions of the data are processed in RAM of a computer.

6. The method of claim 1 or claim 4 in which a user may define a terminal generation by specifying a minimum distance range applicable to all dimensions of each ISD vector subspace.

7. The method of claim 1 or claim 4 in which each of the pharmacophore sites is characterized by one or more of the following chemical features: a) hydrogen bond acceptor; b) hydrogen bond donor; c) hydrophobe; d) negative ionizable; e) positive ionizable; and f) aromatic ring.

8. The method of claim 1 or claim 4 in which n is between 3 and 21.

9. The method of claim 1 or claim 4 in which the proposed set of pharmacophore features is used to select candidate drugs from a library of potential drugs.

10. The method of claim 9 in which one or more candidate drugs is subjected to an experimental evaluation.

11. The method of claim 10 in which data from said experimental evaluation is used to add at least one of the candidate drugs to the set of ligands to produce a revised set of ligands and the steps of claim 1 are repeated using the revised set of ligands.

12. The method of claims 1, 2, or 3 in which the set of ISD vectors is initially stored on a disk on a computer, the method further comprising:
identifying a memory threshold LD;
storing results of the iterative partitioning on the disk when the results exceed the memory threshold; and
storing the results of the iterative partitioning in a memory of the computer when the results meet the memory threshold LD.

13. A computer-readable medium for use in determining a set of proposed pharmacophore features describing interactions between a known biological target and a set of ligands that show activity towards the target, the computer-readable medium bearing instructions that cause a computer to:
identify a set of n-dimensional inter-site distance (ISD) vectors, the set comprising at least one ISD vector for each of two or more ligands, each of the ISD vectors being associated with a specific set of pharmacophore sites within a single conformation of one of the ligands, each of the ISD vectors having the same number and types of pharmacophore sites as other ISD vectors in the set; and
determine, from a top-level multi-dimensional space, a refined, smaller multi-dimensional space defining the distance ranges for each dimension of the ISD vectors in each of at least three dimensions, said distance ranges being used to propose spatial relationships among said set of pharmacophore features.

14. The computer-readable medium of claim 13, in the instructions for determining the smaller multi-dimensional space includes instructions causing the computer to:
identify a dimension i of the ISD vectors;
identify a range of values of the ith coordinates of the ISD vectors;
partition the range of values into intervals;
identify partitions that include the values of the ith coordinate of a predetermined number of ISD vectors; and
iteratively partition only the intervals that include the ith coordinate of the predetermined number of ISD vectors, until a stopping condition is met.

15. The computer-readable medium of claim 14, further comprising instructions for identifying a minimum distance ε, in which an overlap between any two intervals is at most ε, and in which the stopping condition includes that a size of each partition does not exceed ε.

16. The computer-readable medium of claim 13, in which the set of ISD vectors is initially stored on a disk of the computer, the instructions further causing the computer to
identify a memory threshold LD;
store results of the iterative partitioning on the disk when the results exceed the memory threshold; and
store the results of the iterative partitioning in a memory of the computer when the results meet the memory threshold.

17. The computer-readable medium of claim 13, in which a user may define a terminal generation by specifying a minimum distance range ε applicable to all dimensions of each ISD vector subspace.

18. The computer-readable medium of claim 13, in which each of the pharmacophore sites is characterized by one or more of the following chemical features: a) hydrogen bond acceptor; b) hydrogen bond donor; c) hydrophobe; d) negative ionizable; e) positive ionizable; and f) aromatic ring.

19. The computer-readable medium of claim 13 in which n is between 3 and 21.

20. The computer-readable medium of claim 13 in which the instructions further cause the computer to use the proposed set of pharmacophore features to select candidate drugs from a library of potential drugs.

21. The computer-readable medium of claim 20 in which the instructions further cause the computer to subject the candidate drugs to an experimental evaluation.

22. The computer-readable medium of claim 21 in which the instructions further cause the computer to:
identify data from said experimental evaluation;
add at least one of the candidate drugs to the set of ligands, thereby producing a revised set of ligands; and
repeat the instructions of claim 13 on the revised set of ligands.
